(19) United States
(12) Patent Application Publication
(10) Pub. No.: US 2023/0083822 A1
(43) Pub. Date: Mar. 16, 2023

(54) OPTIMIZED RENDERING OF WEB PAGES

(71) Applicant: International Business Machines Corporation, Armonk, NY (US)

(72) Inventors: Jia Zhong Wu, Xi'an (CN); Yang Yang, Xian (CN); Ye Fan, Xian (CN); Juan Wu, Xi'an (CN); Long Fan, Xian (CN); Qi Mao, Xi'an (CN); Jing Xu, Xi'an (CN); Xue Ying Zhang, Xi'an (CN)

(21) Appl. No.: 17/447,836

(22) Filed: Sep. 16, 2021

(51) Int. Cl. G06F 16/957

(52) U.S. Cl. CPC G06F 16/9577; G06F 16/9574

(57) ABSTRACT

One or more computer processors determine a web segment in a web page to be displayed in a visual area and a rendering mode for the web segment. The one or more computer processors retrieve content in the web segment, wherein retrieving the content comprises: in response to the content being cached in a cache memory, retrieving, by one or more processors, the content from the cache memory. The one or more computer processors render the retrieved content to be displayed in the visual area according to the determined rendering mode for the web segment.

### BACKGROUND

The present invention relates generally to the field of computer technologies, and more particularly to optimized rendering of web pages.

Many web pages today contain various types of content for enhancing the experience of a user who downloads and displays a web page utilizing a client computing device and/or client agent, typically a browser. Hyper Text Markup Language (HTML) is a commonly used format to provide content in web pages. To display visual presentation of content in a web page, different rendering methods may be needed to render different types of content.

### SUMMARY

Embodiments of the present invention disclose a computer-implemented method, a computer program product, and a system. The computer-implemented method includes one or more computer processers determining a web segment in a web page to be displayed in a visual area and a rendering mode for the web segment. The one or more computer processors retrieve content in the web segment, wherein retrieving the content comprises: in response to the content being cached in a cache memory, retrieving, by one or more processors, the content from the cache memory. The one or more computer processors render the retrieved content to be displayed in the visual area according to the determined rendering mode for the web segment.

### BRIEF DESCRIPTION OF THE DRAWINGS

FIG. 1 (i.e., FIG.) depicts a cloud computing node in accordance with some embodiments of the present disclosure;

FIG. 2 depicts a cloud computing environment in accordance with some embodiments of the present disclosure;

FIG. 3 depicts abstraction model layers in accordance with some embodiments of the present disclosure;

FIGS. 4A and 4B depict example web pages with content in web segments in accordance with some embodiments of the present disclosure;

FIG. 5 depicts a block diagram of an example environment for web page rendering in accordance with some embodiments of the present disclosure;

FIG. 6A depicts an example of web segments in a web page in accordance with some embodiments of the present disclosure;

FIG. 6B depicts an example of web segment updating in a web page in accordance with some embodiments of the present disclosure;

FIG. 7 depicts a block diagram of an example environment illustrating a detailed structure of the client in accordance with some embodiments of the present disclosure;

FIG. 8 depicts a flowchart of an example process for web segment retrieval in accordance with some embodiments of the present disclosure;

FIG. 9 depicts a flowchart of an example process for web segment rendering in accordance with some embodiments of the present disclosure;

FIG. 10 depicts a flowchart of an example process for web segment retrieval in accordance with some embodiments of the present disclosure; and

FIG. 11 depicts a flowchart of an example method in accordance with some embodiments of the present disclosure.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

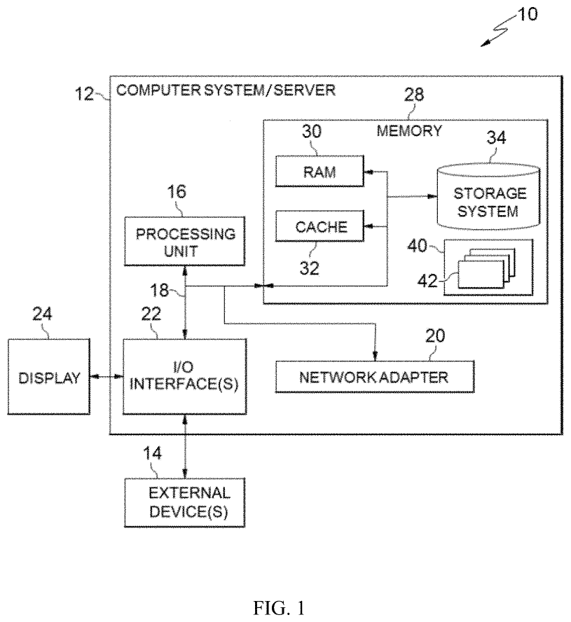

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor units 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

The present invention may contain various accessible data sources that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 40 provides informed consent, with notice of the collection of personal data, allowing the user to opt in or opt out of processing personal data. Consent can take several forms. Opt-in consent can impose on the user to take an affirmative action before the personal data is processed. Alternatively, opt-out consent can impose on the user to take an affirmative action to prevent the processing of personal data before the data is processed. Program 40 enables the authorized and secure processing of user information, such as tracking information, as well as personal data, such as personally identifying information or sensitive personal information. Program 40 provides information regarding the personal data and the nature (e.g., type, scope, purpose, duration, etc.) of the processing. Program 40 provides the user with copies of stored personal data. Program 40 allows the correction or completion of incorrect or incomplete personal data. Program 40 allows the immediate deletion of personal data.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

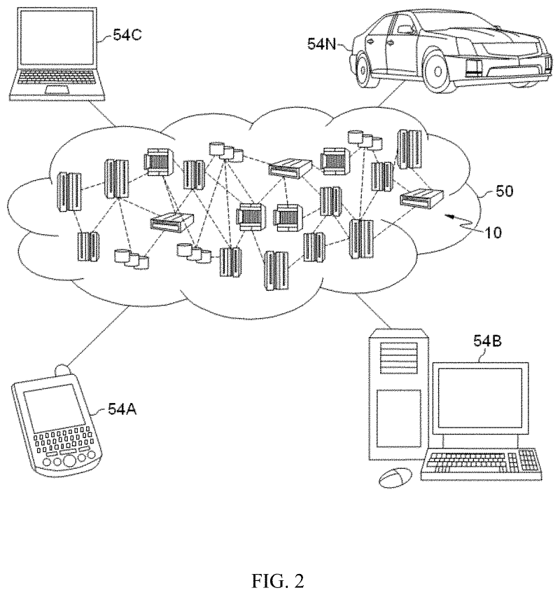

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

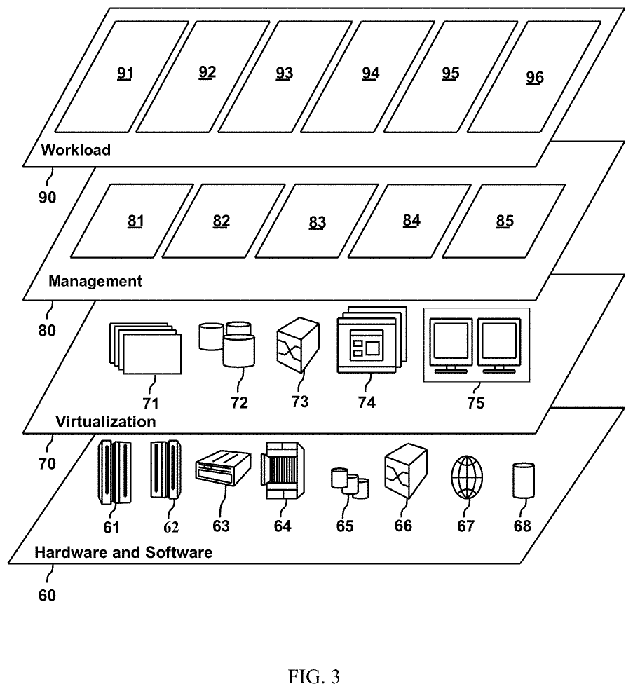

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and web page rendering 96. The functionalities of web page rendering 96 will be described in the following embodiment of the present disclosure.

A web page may comprise a number of web segments each responsible for displaying different content in the web page. In some embodiments, content in a web segment to be displayed may be referred to as an “asset” in the web page. A web page may be formatted as a structured document representing the web segments in a certain structure such as a hierarchical tree-like data structure. An example of such structure is the Document Object Model (DOM) tree. A web page may be based on HTML standards or any other XML-compliant, XML-like, or XML-based markup languages.

The DOM tree is a set of specifications describing a model for representing web content in the form of a tree. The tree is generally formed from nodes to which web segments of a web page correspond, the hierarchy of the nodes being in accordance with the hierarchy of the web segments within the web page. Thus, a web segment in a web page is considered to be corresponding to a node in the hierarchy of the DOM tree.

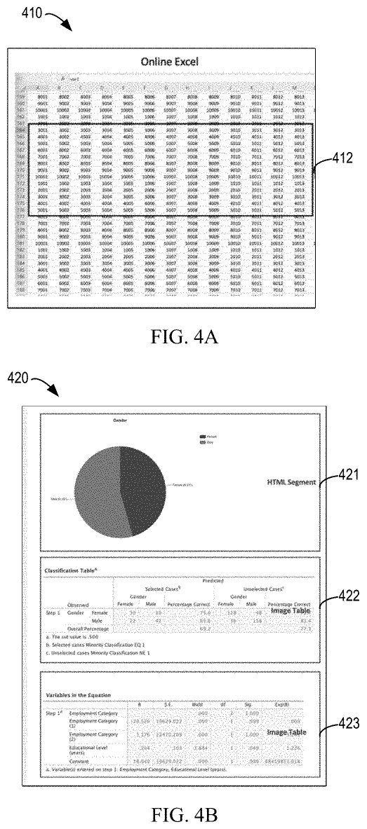

In a practical application where a displayable region of an entire web page is greater than a display area (e.g., a display interface) of a client device used to output the rendered web page, a portion of the web page is displayed in the visual area. The portion of the web page that is displayed in the visual area may be scrollable so as to permit the user to view other portions of the web page, for exampling by scrolling a mouse. FIG. 4A illustrates an example web page 410 which presents an online Excel document with a data table. A portion of the web page 410 is displayed in a visual area 412. By scoring a mouse, other portions of the web page 410 may be presented.

The content of web segments in a web page may be rendered to be displayed to a user. Conventionally, paging and loading on demand and remote rendering are supported. Paging and loading on demand allow portions of a web page, not the entire web page to be downloaded at a time from the server. Thus, the portion of the web page in the visual area (such as the portion in the visual area 412 in FIG. 4A) is downloaded when the user navigates to this portion. The remote rendering requires the server to provide rendered portions of the web page to the client. The client may cache the rendered portions received from the server and display one or more of the rendered portions via browser when the user navigates to those portions in the web page.

In some cases, a web page may comprise a large amount of web segments to present various types of content, which means that the DOM tree may consist of a plurality of nodes indicating said web segments. Examples of content feasible in a web page may include image charts, image tables, videos, HTML segments, Jason-format data, and the like. FIG. 4B illustrates another example web page 420 which includes a web segment 421 presenting a chart, and web segments 422 and 423 presenting image tables.

Generally, different types of content may require different rendering techniques. According to a remote rendering technique, the server may render the currently displayed web page in its entirety at once and provide the rendered portions, if on demand paging and loading is supported by the client. Due to the large amount of content contained in a web page and different rendering techniques required for the content, it places high computational pressure on the server to perform and transmit the rendering, while the client stores the rendered result. In some embodiments, web segments in a web page vary with time, forcing rendering methods to be undesirably reselected and the rendering processing, undesirably, reapplied.

In accordance with embodiments of the present disclosure, there is provided a solution for the optimized rendering of web pages. In this solution, a server provides content in a web segment and a rendering mode for the content to a client. In this embodiment, there is no need for the server to perform the rendering. The client stores the content and has a caching mechanism for the content to allow quick access. If it is determined that the web segment is to be displayed, the client determines whether the corresponding content is cached in a cache memory and retrieves the content from the cache memory in case of a cache hit. The content can be rendered through the client according to the rendering mode indicated by the server.

According to this solution, the caching mechanism allows the client to quickly retrieve content of web segments in a web page when the web segments are to be displayed. The rendering performed at the client can eliminate processing pressure at the server and improve system efficiency. With the rendering modes indicated to the client, if the content in the web segments changes, their rendering modes may be determined and the rendering is performed when the web segments are moved to the visual area, which may optimize the loading and rendering performance of the web page.

Some example embodiments of the present disclosure will be described in detail with reference to the accompanying figures.

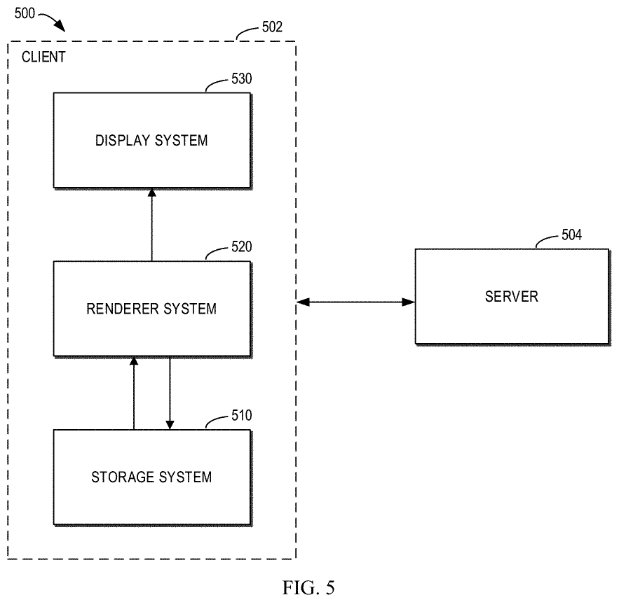

FIG. 5 depicts a block diagram of environment 500 for web page rendering, in accordance with some embodiments of the present disclosure. As illustrated, environment 500 includes a client 502 and a server 504. The client 502 obtains and displays web pages provided from the server 504 (e.g., a web server). To display a web page, content comprised in the web page is to be rendered. The client 502 comprises a storage system 510, a renderer system 520, and a display system 530 (e.g., a browser).

It would be appreciated that the client 502, the server 504, and/or the systems comprised in the client 502 may be implemented by one or more computing systems or devices having computing and storage capability, such as one or more computing platforms, servers, mainframes, general-purpose computing devices, and/or the like. In some embodiments, the client 502 may be any terminal or user device.

In embodiments of the present disclosure, instead of requesting and downloading rendered content from a server, un-rendered content in web segments and indications of corresponding rendering modes are provided from the server 504 to the client 502. The client 502 may store the content and the indications of their rendering modes. The client 502 can render content in a web segment when it determines that the web segment is to be displayed in a visual or viewable area. For other web segments in a non-visual or non-viewable area, there is no need to render non-viewable web segments. The storage system 510 in the client 502 is configured to receive and store information related to a web segment in a web page, and the renderer system 520 in the client 502 is configured to dynamically render content in a web segment to display in the visual area of the client 502.

To allow requesting of a web segment from the server 504 and/or retrieving of content in the web segment within the client 502, information related to a web segment in a web page may be specifically defined. To better understand the following embodiments, example embodiments for information related to a web segment are first introduced.

A web page may include a number of web segments each comprising different contents. In some embodiments, as content in a web page may change, it is supported that a web page includes a sequence of web segments Sₖ, and information related to the web segments in a web page at a time tₖ may be defined as follows:

f(tₖ, Sₖ)={(nₖ_{ᵢ}, Cₖ_{ᵢ}, Aₖ_{ᵢ})}, i ∈(0, mₖ)

where Nₖ_{ᵢ} represents a segment identification (ID) of an i-th web segment in a web page at the time tₖ; Cₖ_{ᵢ} represents an indication of a rendering mode used to render content in the i-th web segment at the time tₖ; Aₖ_{ᵢ}. represents the content (asset) in the i-th web segment at the time tₖ; Tₖ_{ᵢ} represents a timestamp for the i-th web segment at the time tₖ and mₖ represents the total number of web segments in the web page at the time tₖ.

The timestamp Aₖ_{ᵢ} may be used as a version indication of the content in the i-th web segment. Thus, in the case that content of a same web segment changes with time, a combination of the timestamp and the segment identification may be used to uniquely identify the web segment with the content updated at the time tₖ. It would be appreciated that there may be some other identification that can be used to distinguish among versions of content in a same web segment, in addition to use the combination of the segment identification and the timestamp. The scope of the present disclosure is not limited herein.

In some embodiments, the rendering mode indicated by the indication Cₖ_{ᵢ} may include a callback function for one or more renderers used to render the corresponding content. The renderers may be implemented locally at the client 502 and/or remotely, and various rendering techniques may be applied depending on the types of content and actual applications. The scope of the present disclosure is not limited herein.

If a web page includes a plurality of web segments, one or more of the web segments may be displayed in a visual area of the client 502.

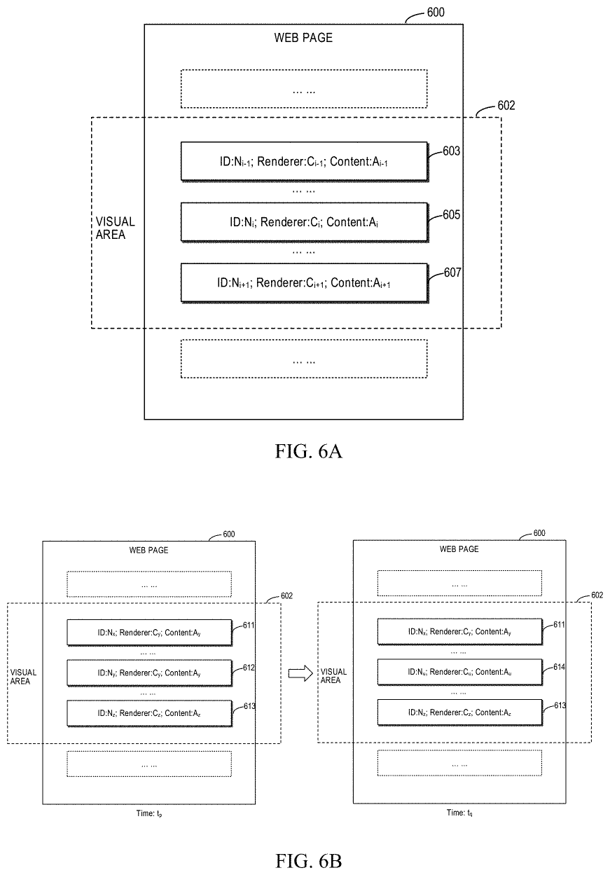

FIG. 6A depicts an example of web segments in a web page 600 in accordance with some embodiments of the present disclosure. In this example, web segments 603, 605, and 607 are displayed in a visual area 602. Segment identifications, indications of rendering modes, and content in those web segments are illustrated in FIG. 6A.

In some cases, web segments of a web page may change and at a certain time, one or more changed web segments may be moved to the visual area for display. Without loss of generality, it is supposed that a set of web segments located in a visual area at a time tₚ is Sₚ, and a set of web segments located in a visual area at a next time t_{q} is S_{q}. The difference set at the two times may be determined as ΔS=S_{q}−Sₚ, which may include zero, one, or more web segments that have been changed from the time tₚ to the time t_{q}.

FIG. 6B depicts an example of web segment updating in the web page 600 in accordance with some embodiments of the present disclosure. At the time tₚ, web segments 611, 612, and 613 are displayed in the visual area 602. The segment identifications, indications of rendering modes, and content in those web segments are illustrated in FIG. 6B. At the time t_{q}, web segments 611, 614, and 613 are displayed in the visual area 602. The segment identifications, indications of rendering modes, and content in those web segments are illustrated in FIG. 6B. By comparing the web segments in the visual area 602 from the time tₚ to the time t_{q}, the web segment 614 is an updated web segment at the time t_{q}.

The renderer system 520 is configured to determine which web segment(s) is to be displayed in the visual area of the display system 530 and render the web segment(s) to be displayed. In some embodiments, if a web segment is loaded in the visual area, the renderer system 520 may not need to re-obtain the content in the web segment. Otherwise, the renderer system 520 may obtain the content in that web segment and render the content based on the corresponding rendering mode for that web segment.

In some embodiments, the client 502 may determine that a web segment to be displayed in the visual area is updated and request for the content of the updated web segment from the server 504. For example, the client 502 may request for ΔS from the server 504. In some embodiments, both an explicit update and an implicit update of a web segment in a web page are supported. In the case of the explicit update, a user or an owner of the web page may be allowed to edit the web page, for example, by changing content in a web segment (e.g., replacing an image with another image), by deleting the web segment (e.g., deleting a table from the web page), or by adding an additional web segment (e.g., by adding a chart into the web page). In the case of the implicit update, syntax instructions may be provided by the user or the owner of the web page to edit the structure of web segments in a web page, or to replace, delete or add one or more segments. The syntax instructions may be provided to the server 504 which compiles and re-configure the DOM tree of the web page.

In the case of the explicit update, the client 502 may transmit a request indicating an updated web segment to the server 504. If the web segment is changed to include new content or has a new or modified location in the web page, the server 504 may transmit the content in the web segment to the client 502. In the case of the explicit update, the server 504 may determine and actively transmit information related to the updated web segment to the client 502. In either case, as will be described below, the storage system 510 may receive and store information related to (updated) web segments in a web page from the server 504.

The renderer system 520 can retrieve the locally stored content in a web segment to be displayed in the visual area and render the content. Since the renderer system 520 may dynamically render content in some web segments located in the visual area, in some embodiments, the storage system 510 and the renderer system 520 may apply a two-level storage mechanism to improve the access efficiency of the content.

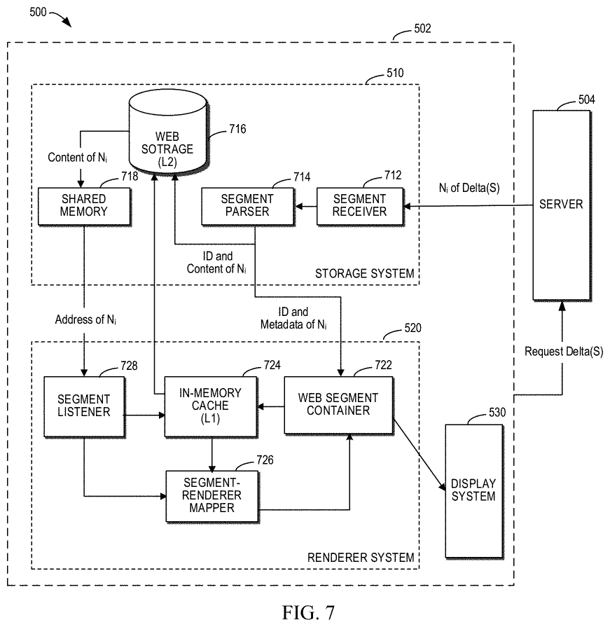

To better understand the functionalities of the storage system 510 and the renderer system 520, reference is now made to FIG. 7 depicting a block diagram of an example environment illustrating a detailed structure of the client 502 in accordance with some embodiments of the present disclosure.

As illustrated, the storage system 510 comprises a segment receiver 712, a segment parser 714, web storage 716, and optionally a shared memory 718 which is shared between the storage system 510 and the renderer system 520. The renderer system 520 comprises a web segment container 722, an in-memory cache 724 (or a cache memory), a segment-renderer mapper 726, and a segment listener 728. The functionalities of the components in the storage and renderer systems shown in FIG. 7 are described below.

It would also be appreciated that the components of the storage and renderer systems shown in FIG. 7 may be implemented as one or more software engines, components, or the like, which are configured with logic for implementing the functionality attributed to the particular module. Each component may be implemented using one or more of such software engines, components or the like. The software engines, components, and the like are executed on one or more processors of one or more computing systems or devices and utilize or operate on data stored in one or more storage devices, memories, or the like, on one or more of the computing systems (least recently used cache in memory and asset database inside a browser) to cache large assets rather than fetching from a server.

The web segment container 722 may be configured to determine a structure of a web page and determine which web segment(s) is to be displayed in the visual area. In some embodiments, to display a web page (or a portion of the web page) in a visual area, the client 502 may obtain and render content of web segments located in the visual area. At the beginning of display of the web page, the client 502 may request structure data of the web page from the server, such as the DOM tree of the web page. At this moment (represented as to), a set of web segments located in the visual area S₀ may be considered as an empty set. The updated set of web segment for the visual area ΔS includes one or more web segments located in the visual area.

In such case, the web segment container 722 may determine, for example, based on the structure data indicating a hierarchy structure of web segments, that one or more web segments located in the visual area may needed to be requested from the server. The web segment container 722 may initiate a request to request the one more web segments ΔS located in the visual area. The server 504 may transmit information related to the requested web segment(s) to the client 502, more specifically, to the segment receiver 712.

In some cases, if one or more web segments are implicitly changed, for example, through syntax instructions, the server 504 may actively notify information related to the changed web segments to the client 502, or more specifically, to the segment receiver 712. In some embodiments, to support the active communication from the server 504 to the client 502, a web socket may be established between the server 504 and the client 502. The information related to the changed web segments may be transmitted to the client 502 through the web socket. In other examples, other communication interface may be used for the communication between the server and the client.

The storage system 510, upon receiving the information related to the web segment(s), may perform corresponding operations to implement the storing and the information access.

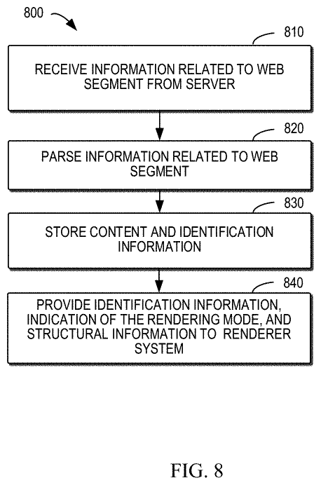

FIG. 8 depicts a flowchart of an example process 800 for web segment receiving in accordance with some embodiments of the present disclosure. The process 800 may be implemented at the storage system 510.

At block 810, the storage system 510 receives information related to a web segment from the server 504. In some embodiments, the segment receiver 712 in the storage system 510 may be configured to communicate with the server 504 and receive the information from the server 504.

In the illustrated example in FIG. 7, for the purpose of discussion, it is assumed that a web segment received from the server 504 is identified as N. It would be appreciated that more than one web segment may be processed in the process 800 and other processes and embodiments as will be described. The information may include at least content in the web segment Nᵢ, and an indication of a rendering mode for the web segment Nᵢ.

In some examples, the information may further include a segment identification of the web segment Nᵢ and a version indication of the content, such as a timestamp, as discussed above. In some examples, the information may further include metadata for the web segment Nᵢ, such as structural information of web segment Nᵢ, which may indicate, for example, a size of the web segment, a style of the web segment, and an indication of a parent node of the web segment in the hierarchy structure of the web page. The structural information may indicate a location of the web segment Nᵢ within the web page.

At block 820, the storage system 510 parses the received information related to the web segment Nᵢ, to obtain the content, indication of the rendering mode, and probably the segment identification, the version indication, and the metadata.

At block 830, the storage system 510 (e.g., the segment parser 714 in the storage system 510) stores the content and identification (ID) information of the web segment Nᵢ into the web storage 716. The identification information may include the segment identification and the version indication (e.g., the timestamp) to uniquely identify the content in the web segment Nᵢ at this time.

The web storage 716 may be a storage device such as a disk or a higher level cache, such as a L2 cache. The access speed of the web storage 716 may be lower than the in-memory cache 724 in the renderer system 520. In some embodiments, the web storage 716 may be configured as a database, such as a key-value database. In some embodiments, the segment identification and the version indication may be used as a key or an index for localize the content in the web segment Nᵢ from the web storage 716.

At block 840, the storage system 510 (e.g., the segment parser 714 in the storage system 510) provides the identification information, an indication of the rendering mode, and the structural information of the web segment Nᵢ to the renderer system 520 (e.g., the web segment container 722). The web segment container 722 may be informed of the rendering mode. In addition, with the structural information, the web segment container 722 in the renderer system 520 may determine the updated structure of the web page if the web segment Nᵢ is a new web segment or a web segment whose location is changed in the web page. With the updated structure of the web page, the renderer system 520 may be able to determine correctly which web segment(s) of the updated version of the web page is to be displayed in the visual area.

The renderer system 520 may operate in parallel with the storage system 510, to perform rendering of the web page. In some embodiments, functionalities in the storage system 510 and the renderer system 520 may be performed in different threads which may be run in parallel, to improve efficiency.

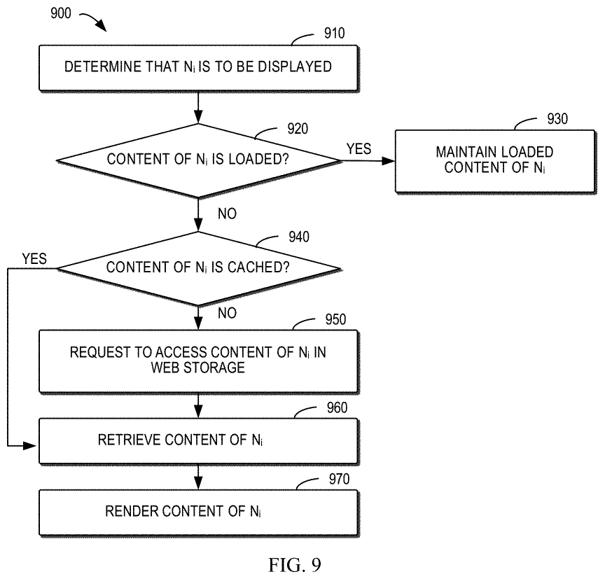

FIG. 9 depicts a flowchart of an example process 900 for web segment rendering in accordance with some embodiments of the present disclosure. The process 900 may be implemented at the renderer system 520.

The renderer system 520 (e.g., the web segment container 722) determines dynamically which web segment(s) is/are to be displayed in the visual area. At block 910, the renderer system 520 (e.g., the web segment container 722) determines that the web segment N, is to be displayed. The web segment container 722 may be informed of the structure or the updated structure of the web page and may be able to determine web segment(s) is located in the visual area.

At block 920, the renderer system 520 (e.g., the web segment container 722) determines whether content in the web segment Nᵢ is loaded. If the content in the web segment is currently displayed in the visual area, the web segment container 722 may determine that the content is loaded.

At block 930, if it is determined that the content in the web segment Nᵢ is loaded, the renderer system 520 (e.g., the web segment container 722) maintains the loaded content in the web segment Nᵢ which may then be provided to the display system 530 for display in the visual area.

At block 940, if it is determined that the content in the web segment Nᵢ is loaded, the renderer system 520 (e.g., the web segment container 722) determines whether the content in the web segment Nᵢ is cached in the in-memory cache 724. The web segment container 722 may query the content in the web segment Nᵢ from the in-memory cache 724, for example, by providing identification information of the content (e.g., the segment identification and the timestamp) to the in-memory cache 724.

The in-memory cache 724 is a cache memory which can provide a high access speed. In some embodiments, the in-memory cache 724 may be a L1 cache, and may have a higher access speed than the web storage 716 in the storage system 510. In some embodiments, the in-memory cache 724 may be based on a latest recently used (LRU) mechanism, which means that the latest recently used data may be stored and the old data may be discarded from the in-memory cache 724. As such, the size of the in-memory cache 724 may not be too large to support the caching of the content of web segments.

In some cases, the content in the web segment Nᵢ may be cached in the in-memory cache 724, for example, because the content in the web segment Nᵢ was previously displayed and then became non-viewable, for example, as the user scrolled to another portion of the web page.

If the content in the web segment Nᵢ is cached in the in-memory cache 724 (i.e., a cache hit is found), at block 960, the renderer system 520 (e.g., the web segment container 722) retrieves the content from the in-memory cache 724. By caching the content the in-memory cache 724, the web segment container 722 may be able to quick access and retrieve the content, for example, as the user scrolls back to the portion of the web page where the web segment Nᵢ is located.

If the content in the web segment Nᵢ fails to be cached in the in-memory cache 724 (i.e., a cache miss is found), at block 950, the renderer system 520 requests to access the content in the web segment Nᵢ in the web storage 716. In some embodiments, the in-memory cache 724 may directly request for the content in the web segment Nᵢ if the cache miss is found. In some embodiments, in the case of the cache miss, the in-memory cache 724 may return a result of cache miss to the web segment container 722 or other component in the renderer system 520, which may then initiate the request for the content in the web segment Nᵢ to the web storage 716. In some embodiments, the identification information of the content (e.g., the segment identification and the timestamp) of the web segment Nᵢ may be provided to the web storage 716 to identify the content to be requested.

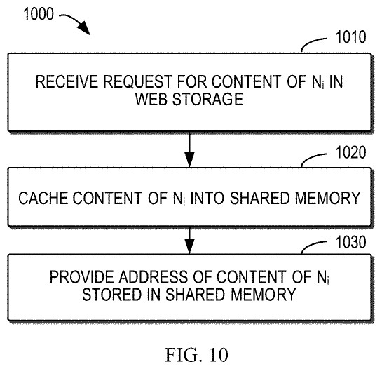

The content retrieving from the web storage 716 will be further discussed below with reference to FIG. 10. The renderer system 520 may retrieve the content in the web segment Nᵢ stored in the web storage 716. For example, the segment listener 728 is configured to obtain the content in the web segment Nᵢ from the web storage 716 in the storage system

After retrieving the content in the web segment Nᵢ from the in-memory 724 or the web storage 716, at block 970, the renderer system 520 (e.g., the segment-renderer mapper 726) renders the content in the web segment Nᵢ according to the rendering mode for the web segment. In some embodiments, in the case where the web segment container 722 determines that the content in the web segment Nᵢ is not loaded, it may register the indication of the rendering mode for the web segment Nᵢ to the segment-renderer mapper 726. With the indication, the segment-renderer mapper 726 may use the corresponding rendering mode to render the content in the web segment Nᵢ. The rendered content may then be displayed by the display system 530.

It can be seen that the web segments in the web page may be rendered locally at the client 502 on demand when they are placed to the visual area. The server 504 may be able to define the register methods/techniques for the web segments, but may not need to perform the actual rendering.

In some embodiments, if the content in the web segment Nᵢ is retrieved from the web storage 716, the content in the web segment Nᵢ may be cached in the in-memory cache 724 for following use.

FIG. 10 depicts a flowchart of an example process 1000 for web segment retrieving in accordance with some embodiments of the present disclosure. The process 1000 may be implemented at the storage system 510.

At block 1010, the storage system 510 (e.g., the web storage 716) receives a request for the content in the web segment Nᵢ in the web storage 716. The request may indicate the segment identification of the web segment Nᵢ and in some examples, a version indication of the content in the web segment. The corresponding content stored in the web storage 716 may be retrieved based on the identification information.

In some embodiments, the retrieved content may be directly provided to the storage system 510. In some cases where the storage system 510 and the renderer system 520 are operated in parallel threads, the communication of the content between two threads may require redundant memory allocation. For example, a memory region may be allocated for the thread of the storage system 510 to buffer the content, and another memory region may be allocated for the thread of the storage system 510 to receive and buffer the content for the storage system 510. In some embodiments, to reduce the memory usage, a shared memory 718 may be provided which is shared by both the threads of the storage system 510 and the renderer system 520. At block 1020, the storage system 510 (e.g., the thread of the storage system 510) caches the content in the web segment Nᵢ retrieved from the web storage 716 in the shared memory 718, and at block 1030, the storage system 510 (e.g., the thread of the storage system 510) provides an address of the content cached in the shared memory 718 to the thread of the renderer system 520. Through the address, the content in the shared memory 718 may be accessed. The passing of an address between two threads may be more efficient at least in term of memory saving and communication.

The thread of the renderer system 520, e.g., the segment listener 728 may receive the address of the content in the web segment Nᵢ. In some embodiments, the segment listener 728 may retrieve the content in the web segment Ni based on the address and cache the content into the in-memory address.

In some embodiments, the segment listener 728 may provide the address to the segment-renderer mapper 726. As the web segment container 722 may receive an indication of the rendering mode for the web segment N, the web segment container 722 may consume the content in the web segment Nᵢ cached in the shared memory 718 based on the address and render the content according to the indicated rendering mode.

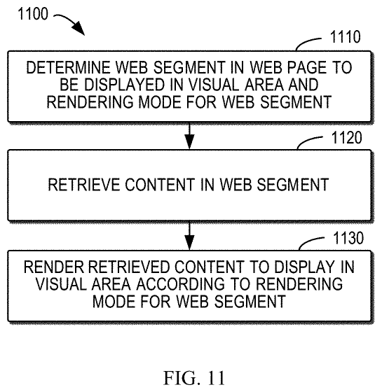

FIG. 11 depicts a flowchart of an example method 1100 in accordance with some embodiments of the present disclosure. The method 1100 may be implemented in the client 502.

At block 1110, the client 502 determines a web segment in a web page to be displayed in a visual area and a rendering mode for the web segment.

At block 1120, the client 502 retrieves content in the web segment. The client 502 retrieving the content comprises: in response to the content being cached in a cache memory, retrieving the content from the cache memory. At block 1130, the client 502 renders the retrieved content to display in the visual area according to the rendering mode for the web segment.

In some embodiments, the retrieving the content further comprises: in response to the content being not cached in the cache memory, retrieving the content from a storage device, the cache memory having a higher access speed than the storage device, wherein the content is stored in the storage device by: receiving, from a server, information related to the web segment, the information at least comprising the content in the web segment and an indication of the rendering mode for the content; and storing the information into the storage device.

In some embodiments, the storing of the information into the storage device is performed in a first thread, and the rendering of the retrieved content is performed in a second thread. In some embodiments, retrieving the content from the storage device comprises: caching the content in a shared memory in the first thread and providing an address of the content cached in the shared memory from the first thread to the second thread.

In some embodiments, rendering the retrieved content comprises: accessing the content from the shared memory in the second thread based on the address of the content; and rendering the accessed content.

In some embodiments, the information further comprises a segment identification of the web segment and a version indication of the content in the web segment, where retrieving the content from the cache memory comprises: retrieving the content from the cache memory using the segment identification and the version indication.

In some embodiments, receiving the information related to the web segment comprises: determining whether the web segment in the web page is updated; in accordance with a determination that the web segment is updated, transmitting to the server, a request for the information related to the web segment; and receiving the information related to the web segment from the server.

In some embodiments, the information further comprises structural information indicating a location of the web segment within the web page, where the present invention updates a structure of the web page based on the structural information; and determines, based on the updated structure of the web page, that the web segment in the web page is to be displayed in the visual area.

It should be noted that the web page rendering according to embodiments of this disclosure could be implemented by computer system/server 12 of FIG. 1. In some embodiments, the client 502, the server 504, or one or more components of the client 502 or the server 504 could be implemented by computer system/server 12 of FIG. 1.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, conventional procedural programming languages, such as the “C” programming language or similar programming languages, and quantum programming languages such as the “Q” programming language, Q#, quantum computation language (QCL) or similar programming languages, low-level programming languages, such as the assembly language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
determining, by one or more processors, a web segment in a web page to be displayed in a visual area and a rendering mode for the web segment;
retrieving, by one or more processors, content in the web segment, wherein retrieving the content comprises:
in response to the content being cached in a cache memory, retrieving, by one or more processors, the content from the cache memory; and
rendering, by one or more processors, the retrieved content to be displayed in the visual area according to the determined rendering mode for the web segment.

2. The computer-implemented method of claim 1, wherein retrieving the content, comprises:
in response to the content being not cached in the cache memory, retrieving, by one or more processors, the content from a storage device, wherein the cache memory has a higher access speed than the storage device, wherein the content is stored in the storage device by:
receiving, by one or more processors, from a server, information related to the web segment, the information at least comprising the content in the web segment and an indication of the rendering mode for the content; and
storing, by one or more processors, the information into the storage device.

3. The computer-implemented method of claim 2, wherein storing of the information into the storage device is performed in a first thread, and the rendering of the retrieved content is performed in a second thread, wherein retrieving the content from the storage device comprises:
caching, by one or more processors, the content in a shared memory in the first thread; and
providing, by one or more processors, an address of the content cached in the shared memory from the first thread to the second thread.

4. The computer-implemented method of claim 3, wherein rendering the retrieved content comprises:
accessing, by one or more processors, the content from the shared memory in the second thread based on the address of the content; and
rendering, by one or more processors, the accessed content.

5. The computer-implemented method of claim 1, wherein the information further comprises a segment identification of the web segment and a version indication of the content in the web segment, wherein retrieving the content from the cache memory comprises:
retrieving, by one or more processors, the content from the cache memory using the segment identification and the version indication.

6. The computer-implemented method of claim 2, wherein receiving the information related to the web segment comprises:
determining, by one or more processors, whether the web segment in the web page is updated;
responsive to a determination that the web segment is updated, transmitting to the server, by one or more processors, a request for the information related to the web segment; and
receiving, by one or more processors, the information related to the web segment from the server.

7. The computer-implemented method of claim 6, further comprising:
updating, by one or more processors, a structure of the web page based on structural information; and
determining, by one or more processors, based on the updated structure of the web page, that the web segment in the web page is to be displayed in the visual area.

8. A computer program product comprising:
one or more computer readable storage media and program instructions stored on the one or more computer readable storage media, the stored program instructions comprising:
program instructions to determine a web segment in a web page to be displayed in a visual area and a rendering mode for the web segment;
program instructions to retrieve content in the web segment, wherein the program instructions to retrieve the content comprise:
in response to the content being cached in a cache memory, program instructions to retrieve the content from the cache memory; and
program instructions to render the retrieved content to be displayed in the visual area according to the determined rendering mode for the web segment.

9. The computer program product of claim 8, wherein the program instructions, to retrieve the content, comprise:
program instructions to in response to the content being not cached in the cache memory, retrieve the content from a storage device, wherein the cache memory has a higher access speed than the storage device, wherein the content is stored in the storage device by:
program instructions to receive from a server, information related to the web segment, the information at least comprising the content in the web segment and an indication of the rendering mode for the content; and
program instructions to store the information into the storage device.

10. The computer program product of claim 9, wherein the program instructions to store the information into the storage device is performed in a first thread, and the rendering of the retrieved content is performed in a second thread, wherein retrieving the content from the storage device, comprise:
program instructions to cache the content in a shared memory in the first thread; and
program instructions to provide an address of the content cached in the shared memory from the first thread to the second thread.

11. The computer program product of claim 10, wherein the program instructions to render the retrieved content, comprise:
program instructions to access the content from the shared memory in the second thread based on the address of the content; and
program instructions to render the accessed content.

12. The computer program product of claim 8, wherein the information further comprises a segment identification of the web segment and a version indication of the content in the web segment, and wherein program instructions to retrieve the content from the cache memory comprise:
program instructions to retrieve the content from the cache memory using the segment identification and the version indication.

13. The computer program product of claim 9, wherein the program instructions, to receive the information related to the web segment, comprise:
program instructions to determine whether the web segment in the web page is updated;
program instructions to responsive to a determination that the web segment is updated, transmit to the server a request for the information related to the web segment; and
program instructions to receive the information related to the web segment from the server.

14. The computer program product of claim 13, wherein the program instructions stored, on the one or more computer readable storage media, further comprise
program instructions to update a structure of the web page based on structural information; and
program instructions to determine based on the updated structure of the web page, that the web segment in the web page is to be displayed in the visual area.

15. A computer system comprising:
one or more computer processors;
one or more computer readable storage media; and
program instructions stored on the computer readable storage media for execution by at least one of the one or more processors, the stored program instructions comprising:
program instructions to determine a web segment in a web page to be displayed in a visual area and a rendering mode for the web segment;
program instructions to retrieve content in the web segment, wherein the program instructions to retrieve the content comprise:
in response to the content being cached in a cache memory, program instructions to retrieve the content from the cache memory; and
program instructions to render the retrieved content to be displayed in the visual area according to the determined rendering mode for the web segment.

16. The computer system of claim 15, wherein the program instructions, to retrieve the content, comprise:
program instructions to in response to the content being not cached in the cache memory, retrieve the content from a storage device, wherein the cache memory has a higher access speed than the storage device, wherein the content is stored in the storage device by:
program instructions to receive from a server, information related to the web segment, the information at least comprising the content in the web segment and an indication of the rendering mode for the content; and
program instructions to store the information into the storage device.

17. The computer system of claim 16, wherein the program instructions to store the information into the storage device is performed in a first thread, and the rendering of the retrieved content is performed in a second thread, wherein retrieving the content from the storage device, comprise:
program instructions to cache the content in a shared memory in the first thread; and
program instructions to provide an address of the content cached in the shared memory from the first thread to the second thread.

18. The computer system of claim 17, wherein the program instructions to render the retrieved content, comprise:
program instructions to access the content from the shared memory in the second thread based on the address of the content; and
program instructions to render the accessed content.

19. The computer system of claim 15, wherein the information further comprises a segment identification of the web segment and a version indication of the content in the web segment, and wherein program instructions to retrieve the content from the cache memory comprise:
program instructions to retrieve the content from the cache memory using the segment identification and the version indication.

20. The computer system of claim 16, wherein the program instructions, to receive the information related to the web segment, comprise:
program instructions to determine whether the web segment in the web page is updated;
program instructions to responsive to a determination that the web segment is updated, transmit to the server a request for the information related to the web segment; and
program instructions to receive the information related to the web segment from the server.
